(19) United States
(12) Patent Application Publication
(10) Pub. No.: US 2013/0233558 A1
(43) Pub. Date: Sep. 12, 2013

(54) Methods for Servicing Subterranean Wells

(71) Applicant: Diankui Fu, Kuala Lumpur (MY)

(72) Inventor: Diankui Fu, Kuala Lumpur (MY)

(21) Appl. No.: 13/879,027

(22) PCT Filed: Nov. 12, 2010
(86) PCT No.: PCT/RU2010/000666

§ 371 Date: May 20, 2013

(51) Int. Cl. C09K 8/88; E21B 21/00

(52) U.S. Cl. CPC C09K 8/88; E21B 21/003
USPC 166/305.1

(57) ABSTRACT

Methods for controlling fluid flow through one or more pathways in one or more carbonate-rock formations penetrated by a borehole in a subterranean well, comprise injecting into or adjacent to the formation a treatment fluid comprising at least one viscoelastic surfactant; fibers, or a mixture of fibers and particles; and at least one acid. The initial fluid viscosity is sufficient to transport the fibers and particles; however, upon reacting with the carbonate rock, the fluid viscosity falls. The lower fluid viscosity promotes efficient fiber bridging across the pathways, thereby providing diversion.

### BACKGROUND OF THE INVENTION

The statements in this section merely provide background information related to the present disclosure and may not constitute prior art.

This invention relates to methods for servicing subterranean wells, in particular, fluid compositions and methods for operations during which the fluid compositions are pumped into a wellbore, make contact with subterranean formations, and block fluid flow through one or more pathways in the subterranean formation rock.

During the construction and stimulation of a subterranean well, operations are performed during which fluids are circulated in the well or injected into formations that are penetrated by the wellbore. During these operations, the fluids exert hydrostatic and pumping pressure against the subterranean rock formations. The formation rock usually has pathways through which the fluids may escape the wellbore. Such pathways include (but are not limited to) pores, fissures, cracks, and vugs. Such pathways may be naturally occurring or induced by pressure exerted during pumping operations.

During well construction, drilling and cementing operations are performed that involve circulating fluids in and out of the well. If some or all of the fluid leaks out of the wellbore during these operations, a condition known as “fluid loss” exists. There are various types of fluid loss. One type involves the loss of carrier fluid to the formation, leaving suspended solids behind. Another involves the escape of the entire fluid, including suspended solids, into the formation. The latter situation is called “lost circulation”, it can be an expensive and time-consuming problem.

In the context of well stimulation, fluid loss is also an important parameter that must be controlled to achieve optimal results. In many cases, a subterranean formation may include two or more intervals having varying permeability and/or injectivity. Some intervals may possess relatively low injectivity, or ability to accept injected fluids, due to relatively low permeability, high in-situ stress and/or formation damage. When stimulating multiple intervals having variable injectivity it is often the case that most, if not all, of the introduced well-treatment fluid will be displaced into one, or only a few, of the intervals having the highest injectivity. Even if there is only one interval to be treated, stimulation of the interval may be uneven because of the in-situ formation stress or variable permeability within the interval. Thus, there is a strong incentive to evenly expose an interval or intervals to the treatment fluid; otherwise, optimal stimulation results may not be achieved.

In an effort to more evenly distribute well-treatment fluids into each of the multiple intervals being treated, or within one interval, methods and materials for diverting treatment fluids into areas of lower permeability and/or injectivity have been developed. Both chemical and mechanical diversion methods exist.

Mechanical diversion methods may be complicated and costly, and are typically limited to cased-hole environments. Furthermore, they depend upon adequate cement and tool isolation.

Concerning chemical diversion methods, a plethora of chemical diverting agents exists. Chemical diverters generally create a cake of solid particles in front of high-permeability layers, thus directing fluid flow to less-permeable zones. Because entry of the treating fluid into each zone is limited by the cake resistance, diverting agents enable the fluid flow to equalize between zones of different permeabilities. Common chemical diverting agents include bridging agents such as silica, non-swelling clay, starch, benzoic acid, rock salt, oil soluble resins, naphthalene flakes and wax-polymer blends. The size of the bridging agents is generally chosen according to the pore-size and permeability range of the formation intervals. The treatment fluid may also be foamed to provide a diversion capability.

In the context of well stimulation, after which formation fluids such as hydrocarbons are produced, it is important to maximize the post-treatment permeability of the stimulated interval or intervals. One of the difficulties associated with many chemical diverting agents is poor post-treatment cleanup. If the diverting agent remains in formation pores, or continues to coat the formation surfaces, production will be hindered.

A more complete discussion of diversion and methods for achieving it is found in the following publication: Provost L and Doerler N: “Fluid Placement and Diversion in Sandstone Acidizing,” in Economides M and Nolte K G (eds.): Reservoir Stimulation, Schlumberger, Houston (1987): 15-1-15-9.

Viscoelastic surfactants (VES) have been widely used as thickeners for matrix-acidizing fluids, fracture-acidizing fluids and sand-control fluids. They not only increase the treatment-fluid viscosity, but also provide fluid-loss control.

Diversion of VES-base fluids has previously been achieved by several methods. One method (U.S. Pat. No. 7,237,608) involves stimulating a carbonate-rock (limestone or dolomite) formation with a VES solution containing hydrochloric acid. Without wishing to be bound by any theory, as the acid spends, forming calcium chloride, the ionic environment becomes conducive to the formation of wormlike micelles. The wormlike micelles become entangled and form a three-dimensional network, thus the spent acid thickens. The thickened acid inside the rock pores hinders further fluid flow; as a result, the acid is diverted to locations that have not yet been stimulated.

A thorough description of viscoelastic surfactants and the mechanisms by which they provide viscosity is given in the following publications. Zana R and Kaler E W (eds.): Giant Micelles, CRC Press, New York (2007); Abdel-Rahem V and Hoffmann H: “The distinction of viscoelastic phases from entangled wormlike micelles and of densely packed multilamellar vesicles on the basis of rheological measurements,” Rheologica Acta, 45 (6) 781-792 (2006).

U.S. Pat. No. 7,028,775 describes a scenario in which there is a water-producing zone and a hydrocarbon-producing zone. The goal is to suppress water production while stimulating hydrocarbon production. An acidified VES solution is first pumped into the water-producing formation. Upon spending, the VES solution thickens in the pores and hinders further water flow into the wellbore. A second acid fluid is then pumped to stimulate the hydrocarbon-producing formation.

In U.S. Pat. No. 7,318,475, injection of acidified VES solutions is performed selectively during perforation operations, thereby favoring production from desired formation intervals.

U.S. Pat. No. 7,380,602 teaches the addition of chelating agents to acidified VES solutions. The chelating agents retard the rate at which the acid spends upon contact with the formation rock, and helps to prevent the precipitation of iron and other transition metals. Such formulations are particularly useful at higher reservoir temperatures.

U.S. Pat. No. 7,350,572 involves the addition of fibers to acidified VES solutions to improve leakoff control, especially when the carbonate reservoir has natural fractures. The initial viscosity is lower than that after the acid spends in the formation.

The aforementioned techniques, while effective, require the addition of relatively high VES concentrations, involve more than one fluid stage, utilize downhole mechanical devices, or combinations thereof.

Therefore, despite the valuable contributions of the prior art, there remains a need for improved and lower-cost materials and techniques for stimulating carbonate-rock formations.

### SUMMARY OF THE INVENTION

Embodiments provide improved means for solving the aforementioned problems associated with controlling fluid flow from the wellbore into formation rock, and is particularly oriented toward the stimulation of carbonate-rock reservoirs.

In a first aspect, embodiments relate to methods for controlling fluid flow through one or more pathways in one or more carbonate-rock formations penetrated by a borehole in a subterranean well.

In a further aspect, embodiments relate to methods for treating one or more subterranean carbonate-rock formations penetrated by a wellbore.

### BRIEF DESCRIPTION OF THE DRAWINGS

FIG. 1 shows the relationship between fluid viscosity and the fiber concentration necessary to form a bridge across a slot.

FIG. 2 is a schematic diagram of an apparatus for evaluating the plugging ability of a treatment fluid.

FIG. 3 is a detailed diagram of the slot of the apparatus depicted in FIG. 2.

FIG. 4 is a plot showing the viscosity of 1 vol % solutions of erucyl methyl bis (2-hydroxyethyl)ammonium chloride in various concentrations of HCl.

FIG. 5 is a plot showing the viscosity of 1 vol % solutions of erucyl methyl bis (2-hydroxyethyl)ammonium chloride in various concentrations of CaCl₂.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific points, it is to be understood that inventors appreciate and understand that any and all data points within the range are to be considered to have been specified, and that inventors possessed knowledge of the entire range and all points within the range.

Embodiments relate to methods for controlling fluid flow through pathways in rock formations penetrated by a borehole in a subterranean well. The disclosed methods are useful for (but not limited to) treatments associated with well-stimulation operations—matrix acidizing and fracture acidizing in particular.

The treatment fluid may be an aqueous base fluid made with fresh water, seawater, brine, etc., depending upon compatibility with the viscosifier and the formation.

As discussed earlier, viscoelastic surfactants (VES) have been widely used as thickeners for matrix-acidizing fluids, fracture-acidizing fluids and sand-control fluids. They not only increase the treatment-fluid viscosity, but may also provide fluid-loss control and diversion. VES fluids are well known and used for various oilfield applications such as hydraulic fracturing, diversion in acidizing, and leakoff control. VES fluids useful as base fluids in the embodiments include, but are not limited to those available under the tradenames CLEARFRAC™, VDA™, OILSEEKER™ and CLEARPILL™, all of which are available from Schlumberger Limited. Non-limiting examples of suitable VES fluids are described, for example, in U.S. Pat. Nos. 5,964,295; 5,979,555; 6,637,517; 6,258,859; and 6,703,352.

In the context of diversion, the inventor has surprisingly discovered that the addition of fibers to an acidic VES treatment fluid allows the use of lower surfactant concentrations. And, unlike previous art involving VES, the acidic treatment fluid may be designed such that it has a higher initial viscosity, and a lower viscosity after the acid spends in the formation. The higher initial fluid viscosity allows the fibers to be well dispersed and supported during the fluid's journey down the wellbore to the carbonate-rock formation. The lower fluid viscosity after contacting the carbonate-rock formation promotes more efficient fiber bridging and fluid diversion. The higher fiber-bridging efficiency also permits lower fiber concentrations. This effect is illustrated for example in Example 1.

In an aspect, embodiments relate to methods for controlling fluid flow through one or more pathways in one or more carbonate-rock formations penetrated by a subterranean well, comprising injecting into or adjacent to the formation a treatment fluid comprising: (1) at least one viscoelastic surfactant; (2) fibers, or a mixture of fibers and particles; and (3) at least one acid.

In a further aspect, embodiments relate to methods for treating one or more subterranean carbonate-rock formations penetrated by a wellbore comprising: (1) at least one viscoelastic surfactant; (2) fibers, or a mixture of fibers and particles; and (3) at least one acid.

The viscoelastic surfactants may be cationic (for example, quarternary ammonium compounds), anionic (for example, fatty-acid carboxylates), zwitterionic (for example, betaines) or nonionic and mixtures thereof. Without wishing to be bound by any theory, viscoelastic surfactants are believed to provide fluid viscosity by forming rod-like micelles. Entanglement of the micelles in the fluid is thought to create internal flow resistance that is in turn translated into viscosity.

Cationic amine salts and quaternary amine salts of fatty acids are preferred, including (but not limited to) erucyl methyl bis(2-hydroxyethyl)ammonium chloride; erucyl trimethyl ammonium chloride, N-methyl-N-N-bis(2-hydroxyethyl) rapeseed ammonium chloride; oleyl methyl bis(hydroxyethyl)ammonium chloride; erucylamidopropyltrimethylamine chloride; octadecyl methyl bis(hydroxyethyl)ammonium bromide; octadecyl tris(hydroxyethyl)ammonium bromide; octadecyl dimethyl hydroxyethyl ammonium bromide; cetyl dimethyl hydroxyethyl ammonium bromide; cetyl methyl bis(hydroxyethyl)ammonium salicylate; cetyl methyl bis(hydroxyethyl)ammonium 3,4,-dichlorobenzoate; cetyl tris(hydroxyethyl)ammonium iodide; cosyl methyl bis(hydroxyethyl)ammonium chloride; cosyl tris(hydroxyethyl)ammonium bromide; dicosyl methyl bis(hydroxyethyl)ammonium chloride; dicosyl tris(hydroxyethyl)ammonium bromide; hexadecyl ethyl bis(hydroxyethyl)ammonium chloride; hexadecyl isopropyl bis(hydroxyethyl)ammonium iodide; cetylamino, N-octadecyl pyridinium chloride; and combinations thereof. Of these, erucyl methyl bis(2-hydroxyethyl)ammonium chloride is particularly preferred.

In the various embodiments, the preferred viscoelastic-surfactant concentration may be between about 0.2% and 20% by volume, more preferably between about 0.3% and 10% by volume, and most preferably between about 0.5% and 5% by volume. The initial viscosity provided by the viscoelastic surfactants may allow optimal fiber and solids transport and prevent bridging or plugging as the fluid is pumped to its destination through tubulars, tools or annuli.

The fibers of the invention may comprise (but not be limited to) polylactic acid, polyester, polylactone, polypropylene, polyolefin or polyamide and mixtures thereof. The preferred fiber-concentration range is between about 0.6% and 2.4% by weight, which corresponds to about 6 kg/m³ and 24 kg/m³. The preferred fiber-length range is between about 2 mm and 25 mm, more preferably between about 3 mm and 18 mm, and most preferably between about 5 mm and 7 mm. The preferred fiber-diameter range is between about 1 μm to 200 μm, more preferably between about 1.5 μm to 60 μm, and most preferably between about 10 μm and 20 μm. One of the advantages offered by the aforementioned fibers is that, for example, the polypropylene and polyolefin fibers are soluble in liquid hydrocarbons such as crude oil, and the rest will degrade through hydrolysis in the presence of traces of water and heat. With time, they may dissolve and be carried away by the produced hydrocarbon fluid, providing improved cleanup and well production.

Mixtures of fibers may also be used, for example as described in U.S. Patent Application Publication No. 20100152070. For example, the fibers may be a blend of long fibers and short fibers. Preferably, the long fibers are rigid and the short fibers are flexible. It is believed that such long fibers form a tridimensional mat or net in the flow pathway that traps the particles, if present, and the short fibers.

When present, the solid particles may comprise (but not be limited to) polylactic acid, polyglycolic acid, polyester, polyamide, silica, rock salt and benzoic acid and mixtures thereof. For optimal cleanup after the treatment, degradable particles comprising (but not limited to) polylactic acid, polyglycolic acid and polyester are Preferred. The preferred solid-particle-size range is between about 5 μm and 1000 μm, more preferably between about 10 μm and 300 μm, and most preferably between about 15 μm to 150 μm. The preferred solid-particle concentration range is between about 6 g/L and 72 g/L, more preferably between about 12 g/L and 36 g/L, and most preferably between about 15 g/L and 20 g/L.

The acid may comprise inorganic acids, organic acids or both. The acid may comprise (but not be limited to) one or more members of the list comprising hydrochloric acid, acetic acid, formic acid, citric acid, lactic acid, ethylenediamine tetraacetic acid, hydroxyethyl ethylenediamine triacetic acid, hydroxyethyl iminodiacetic acid, diethylene triamine pentaacetic acid and nitrilotriacetic acid.

### EXAMPLES

The following examples serve to further illustrate the invention.

### Example 1

Experiments were performed to determine the relationship between fluid viscosity and the ability of fibers to bridge across a slot, simulating a crack in the formation wall. Fluids based on three thickeners were prepared. The compositions are given below.

System A: Two aqueous solutions were prepared containing a quaternary ammonium salt of a fatty acid (C-6212, available from Akzo Nobel, Chicago, Ill., USA) and a urea ammonium chloride solution (ENGRO 28-0-0, available from Agrium, Calgary, Alberta, CANADA). The first fluid contained 0.5 vol % C-6212 and 1.5 vol % ENGRO 28-0-0. The second fluid contained 0.75 vol % C-6212 and 1.5 vol % ENGRO 28-0-0. The fluid viscosities were 9 cP and 10 cP at 170 s⁻¹, respectively.

System B: Three aqueous solutions were prepared containing erucic amidopropyl dimethyl betaine, available from Rhodia, Cranbury, N.J., USA. The first fluid contained 0.75 vol % of the betaine. The second fluid contained 1.0 vol % of the betaine, and the third contained 1.5 vol % of the betaine. The fluid viscosities were 5 cP, 18 cP and 39 cP at 170 s⁻¹, respectively.

System C: Three aqueous solutions were prepared containing guar gum. The guar-gum concentrations were 2.4 kg/m³, 3.6 kg/m³ and 4.8 kg/m³. The fluid viscosities were 21 cP, 53 cP and 96 cP at 170 s⁻¹, respectively.

The fibers employed in the experiments were made of polylactic acid (PLA). The fibers were 6 mm long and 12 μm in diameter.

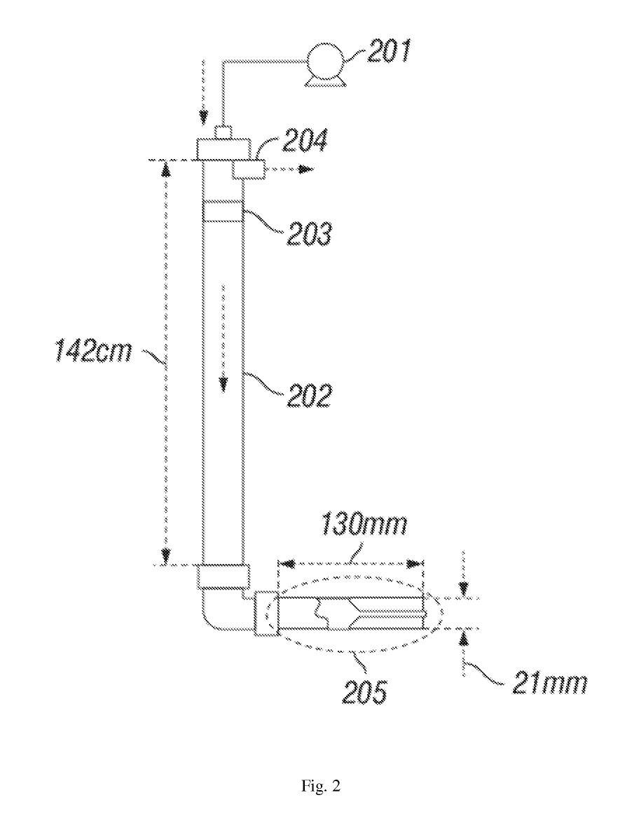

The test apparatus, shown in FIG. 2, was designed to simulate fluid flow into a formation-rock void. A pump 201 is connected to a tube 202. The internal tube volume is 500 mL. A piston 203 is fitted inside the tube. A pressure sensor 204 is fitted at the end of the tube between the piston and the end of the tube that is connected to the pump. A slot assembly 205 is attached to the other end of the tube.

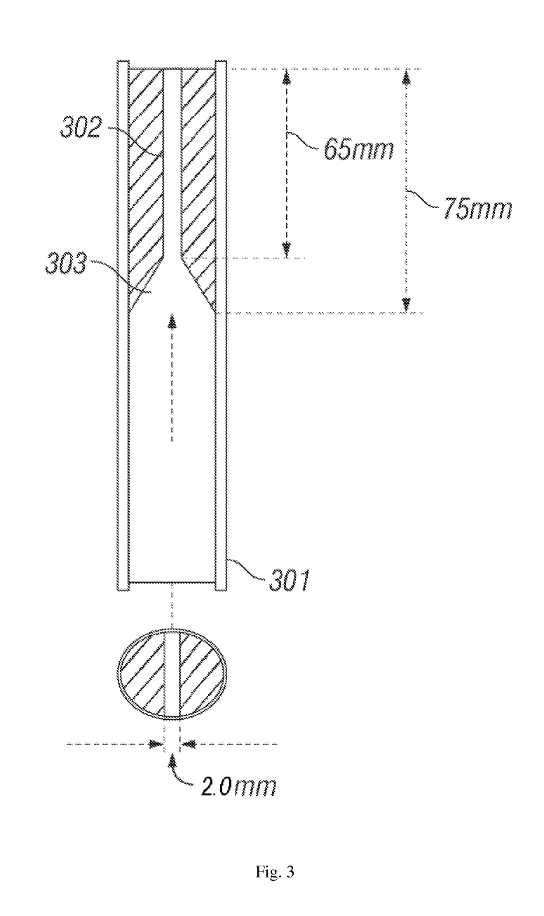

A detailed view of the slot assembly is shown in FIG. 3. The outer part of the assembly is a tube 301 whose dimensions are 130 mm long and 21 mm in diameter. The slot 302 is 65 mm long and 2.0 mm wide. Preceding the slot is a 10-mm long tapered section 303.

For each test, 500 mL of fluid containing PLA fibers were prepared. The fibers were added manually and dispersed throughout the test fluid. After transferring the test fluid to the tube 202, the piston 203 was inserted. The tube was sealed, and water was pumped at a rate whereby the piston-displacement rate was 0.5 m/s (24 mL/min). Fiber bridging across the slot was indicated when the system pressure rose above 0.35 MPa (50 psi).

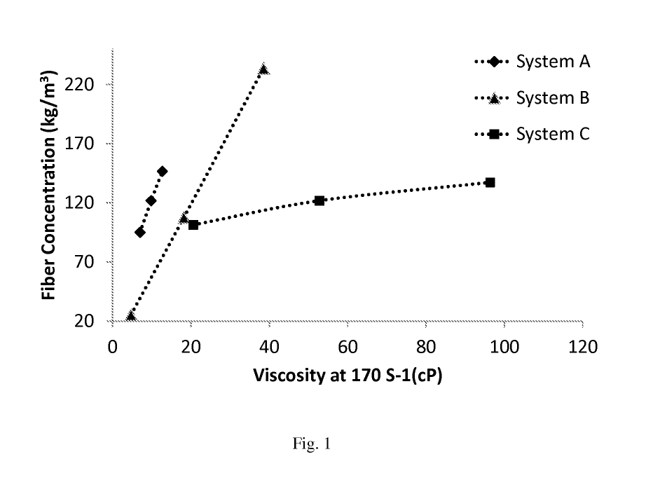

Inspection of FIG. 1 reveals that the fiber concentration necessary to cause bridging across the slot decreases with decreasing fluid viscosity.

### Example 2

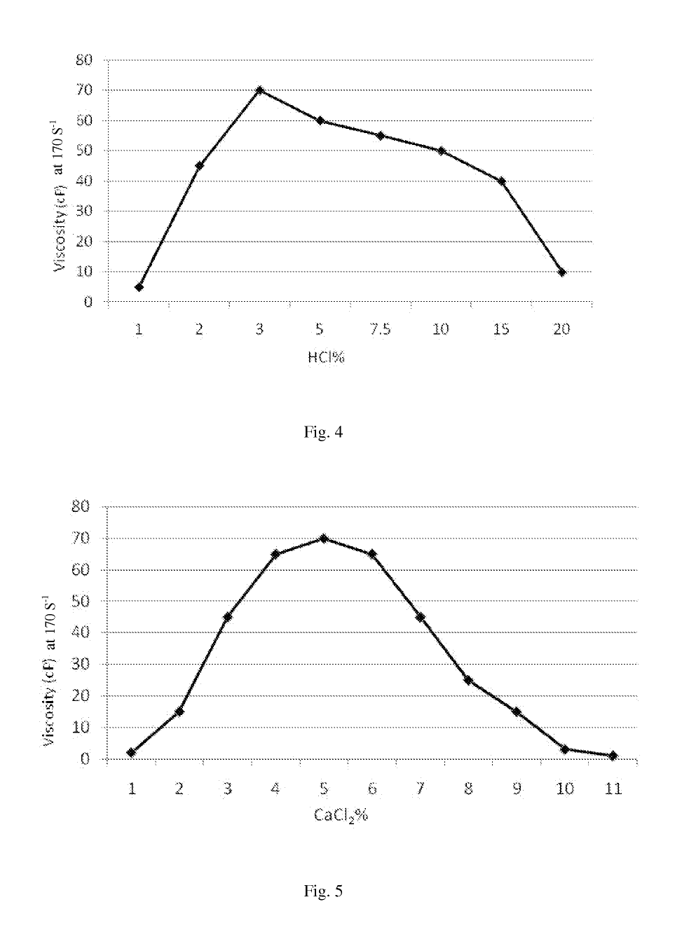

HCl solutions were prepared at the following concentrations: 1, 2, 3, 5, 7.5, 10, 15 and 20 wt %. To each solution, 1 vol % of erucyl methyl bis (2-hydroxyethyl)ammonium chloride was added, and the ambient-temperature viscosity was measured at 170 s⁻¹. The results are presented in FIG. 4. A viscosity peak occurred at 3 wt % HCl.

When HCl contacts a carbonate-rock formation, the reaction product is CaCl₂. CaCl₂ solutions were prepared at the following concentrations: 1, 2, 3, 4, 5, 6, 7, 8, 9, 10 and 11 wt %. To each solution, 1 vol % of erucyl methyl bis (2-hydroxyethyl)ammonium chloride was added, and the ambient-temperature viscosity was measured at 170 s⁻¹. The results are presented in FIG. 5. A viscosity peak occurred at 5 wt % CaCl₂.

Note that 10 wt % HCl will produce about 15 wt % CaCl₂ when it reacts with CaCO₃. Comparing FIGS. 4 and 5, it is apparent that the fluid viscosity would fall from about 50 cP to about 1 cP. Inspection of FIG. 1 shows that the fiber-bridging efficiency would also improve.

1. A method for controlling fluid flow through one or more pathways in one or more carbonate-rock formations penetrated by a borehole in a subterranean well, comprising injecting into or adjacent to the formation a treatment fluid comprising:
i. at least one viscoelastic surfactant;
ii. fibers, or a mixture of fibers and particles; and
iii. at least one acid.

2. A method for treating one or more subterranean carbonate-rock formations penetrated by a wellbore, comprising injecting into or adjacent to the formation a treatment fluid comprising:
i. at least one viscoelastic surfactant;
ii. fibers, or a mixture of fibers and particles; and
iii. at least one acid.

3. The method of claim 1, wherein the acid comprises an inorganic acid, an organic acid or both.

4. The method of claim 1, wherein the acid comprises one or more members of the list comprising: hydrochloric acid, acetic acid, formic acid, citric acid, lactic acid, ethylenediamine tetraacetic acid, hydroxyethyl ethylenediamine triacetic acid, hydroxyethyl iminodiacetic acid, diethylene triamine pentaacetic acid and nitrilotriacetic acid.

5. The method of claim 1, wherein the viscoelastic surfactant comprises one or more members of the list comprising: a cationic surfactant, a nonionic surfactant and a zwitterionic surfactant.

6. The method of claim 1, wherein the viscoelastic surfactant is an amine salt or quaternary ammonium salt of a fatty acid.

7. The method of claim 1, wherein the viscoelastic surfactant is erucyl methyl bis (2-hydroxyethyl)ammonium chloride.

8. The method of claim 1, wherein the viscoelastic-surfactant concentration is between about 0.2% and 20% by volume.

9. The method of claim 1, wherein the initial treatment-fluid viscosity is higher than the treatment-fluid viscosity after contacting the carbonate-rock formation.

10. The method of claim 1, wherein the fibers comprise one or more members of the list comprising polylactic acid, polyglycolic acid, polyester, polylactone, polypropylene, polyolefin and polyamide.

11. The method of claim 1, wherein the fiber concentration is between about 0.6% and 2.4% by weight.

12. The method of claim 1, wherein the fiber length is between about 2 mm and 25 mm, and the fiber diameter is between about 1 μm and 200 μm.

13. The method of claim 1, wherein the particles comprise one or more members of the list comprising polylactic acid, polyglycolic acid, polyester, polyamide, silica, rock salt and benzoic acid.

14. The method of claim 1, wherein the particle concentration is between about 6 g/L and 72 g/L.

15. The method of claim 1, wherein the particle size is between 5 μm and 1000 μm.
